(19) United States
(12) Patent Application Publication
(10) Pub. No.: US 2008/0114923 A1
(43) Pub. Date: May 15, 2008

(54) APPARATUS AND METHOD FOR CONTROLLING OPERATION PROCESSING IN NONVOLATILE MEMORY

(75) Inventors: Ji-hyun IN, Seongnam-si (KR); Jin-kyu Kim, Seoul (KR); Il-hoon Shin, Suwon-si (KR); Se-wook Na, Seoul (KR); Hyo-jun Kim, Yongin-si (KR); Song-ho Yoon, Yongin-si (KR); Dong-kun Shin, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/829,524

(22) Filed: Jul. 27, 2007

(30) Foreign Application Priority Data
Nov. 14, 2006 (KR) 2006-112411

(51) Int. Cl. G06F 12/16; G06F 12/00

(52) U.S. Cl. 711/103; 711/162; 711/E12.103; 711/E12.008

(57) ABSTRACT

An apparatus for controlling operation processing in a nonvolatile memory includes an emergency request-managing unit to set values of a pre-empt flag and a status-backup flag when an operation based on an urgent request is transmitted, a status-checking unit to check the set values of the pre-empt flag and the status-backup flag, and an operation-processing unit to process the operation based on the urgent request and an operation based on a normal request according to the checked values.

### CROSS-REFERENCE TO RELATED APPLICATION

This application claims the benefit of Korean Application No. 2006-112411, filed Nov. 14, 2006, in the Korean Intellectual Property Office, the disclosure of which is incorporated herein by reference.

### BACKGROUND OF THE INVENTION

1. Field of the Invention

Aspects of the present invention relate to an apparatus and method for controlling operation processing in a nonvolatile memory, and more particularly to an apparatus and method for controlling operation processing when an operation for an urgent request is transmitted while a normal operation is being processed, where the apparatus and method suspend the normal operation, and then preferentially perform the urgent operation.

2. Description of the Related Art

Consumer demand for larger software and user data capacity in mobile devices has been increasing recently due to the desire for mobile devices to perform various and complex functions and to have improved multimedia functions. Accordingly, demand has increased for large nonvolatile memories to store code and user data and large volatile memories to operate the code, thus increasing the cost of mobile devices.

Conventional mobile devices use NOR flash memory as a nonvolatile memory to boot and store code, NAND flash memory to store user data, and DRAM to function as a volatile memory. However, many mobile device manufacturers use a method of storing both code and user data in a NAND flash memory in order to reduce costs and improve functionality. A NAND flash memory loads all code into a RAM in order to execute the code because the NAND flash memory cannot execute in place (“XIP”), while the NOR flash memory can execute in place. Recently, a virtual memory system using demand paging has been developed in order to reduce RAM size. Demand paging refers to a technique in which a NAND flash memory is used as an auxiliary backing device. In demand paging, code is not loaded into RAM all at once, and instead, if an accessed page does not exist in the RAM, the page is loaded into the RAM individually.

A case where the accessed page does not exist in the RAM is referred to as an exceptional case. If an exceptional case is not processed, system operations cannot be performed. Accordingly, the accessed page has to be read from the NAND flash memory and then loaded into the RAM in order to execute the code. Since the NAND flash memory stores not only code but also user data, when a code page is downloaded in the exceptional case, the NAND flash memory may also be used to store and extract user data. In this case, the exceptional case should be preferentially processed. Therefore, the read, write, or erase operations being performed when an exceptional case develops should be suspended to preferentially process the exceptional case.

FIG. 1 depicts read and write operations performed in a general NAND flash memory. As shown in FIG. 1, a nonvolatile memory, e.g., a NAND flash memory 20, performs write and read operations on a page-by-page basis. When the NAND flash memory 20 receives a command to perform a read operation, the NAND flash memory 20 loads a corresponding page into a page register 21. At this time, the status of the NAND flash memory 20 is “busy.” When all the data is loaded to the page register 21, the data is transmitted to a host memory 10. While the data is transmitted, the status of the NAND flash memory 20 is “ready.” While in “ready” status, the NAND flash memory 20 is capable of receiving commands. Accordingly, a read operation is not completed until all the data is transmitted from the page register 21 to the host memory 10.

In contrast, a write operation transmits data from the host memory 10 to the page register 21. While the data is transmitted from the host memory 10 to the page register 21, the status of the NAND flash memory 20 is “ready.” After all the data is transmitted from the host memory 10 to the page register 21, the data stored in the page register 21 is written to a NAND cell 22 when a write command is received. While the data of the page register 21 is written, the status of the NAND flash memory 20 changes to “busy.” While in “busy” status, the NAND flash memory 20 cannot receive additional commands. After writing is completed, a result of the write operation is stored in a status register of the NAND flash memory 20.

Korean Unexamined Patent No. 2001-026600 discloses “A Method of Processing Flash Memory in Real Time.” According to this method, when access to a predetermined block of a flash memory is requested in order to perform a read or write operation, a determination is made as to whether the access is possible, and, if such an access is possible, whether an erase operation is being processed, and subsequently suspended, if necessary, to perform a read or write operation. However, Korean Unexamined Patent No. 2001-026600 does not disclose any technique of preferentially performing an urgent operation when a request to perform an urgent operation is transmitted while a normal operation is being performed.

### SUMMARY OF THE INVENTION

Various aspects and example embodiments of the present invention relate to preferentially process an urgent operation based on an urgent request when the urgent request is transmitted while an operation based on a normal request is being processed.

Additionally, aspects of the present invention improve the performance of devices which use nonvolatile memories.

According to an aspect of the present invention, an apparatus to control operations of a nonvolatile memory includes an emergency request-managing unit to set a value of a pre-empt flag and a value of a status-backup flag when an operation for an urgent request is transmitted, a status-checking unit to check the set values of the pre-empt flag and the status-backup flag, and an operation-processing unit to process the operation based on the urgent request and an operation based on a normal request according to the checked values.

According to another aspect of the present invention, a method of controlling operations of a nonvolatile memory corresponding to an apparatus to control the operation processing in the nonvolatile memory includes maintaining a standby mode until an operation based on a normal request is completed, when an urgent request to process an operation is transmitted, setting a value of a status-backup flag after the operation based on the normal request is completed, processing the operation based on the urgent request, and setting a value of a pre-empt flag when the operation based on the urgent request is completed.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 depicts read and write operations performed in a general NAND flash memory;

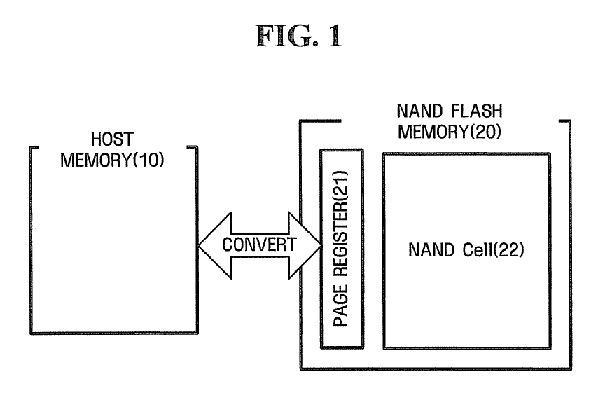

FIG. 2 depicts performing an operation based on an urgent request or a normal request in a device driver in a nonvolatile memory according to an example embodiment of the present invention;

FIG. 3 is a block diagram showing a host apparatus to control operations in a nonvolatile memory according to an example embodiment of the present invention;

FIG. 4 is a flowchart of processing operations based on a normal read request in a nonvolatile memory according to an example embodiment of the present invention;

FIG. 5 is a flowchart of operations based on a normal write request in a nonvolatile memory according to an example embodiment of the present invention;

FIG. 6 is a flowchart of operations based on a normal erase request in a nonvolatile memory according to an example embodiment of the present invention; and

FIG. 7 is a flowchart of operations based on an urgent read request in a nonvolatile memory according to an example embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures. Advantages and features of the present invention and methods of accomplishing the same may be understood more readily by reference to the following detailed description of the exemplary embodiments and the accompanying drawings. Aspects of the present invention may, however, be embodied in many different forms and should not be construed as being limited to the embodiments set forth herein. Rather, these embodiments are provided so that this disclosure will be thorough and complete and will fully convey the concept of the invention to those skilled in the art, and aspects of the present invention will only be defined by the appended claims.

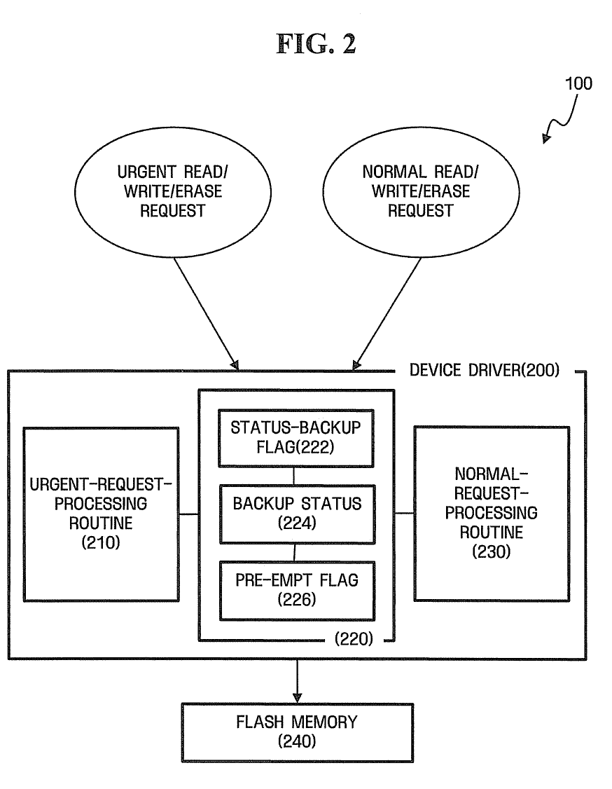

FIG. 2 depicts performing an operation to process an urgent or a normal request in a storage device 100 having a nonvolatile memory, according to an example embodiment of the present invention. As shown in FIG. 2, a storage device 100 having a nonvolatile memory includes a device driver 200 and a flash memory 240. The device driver 200, which processes an operation based on a normal request, also known as a normal operation, to record and/or reproduce data to and/or from he nonvolatile memory, and an operation based on an urgent request, also known as an urgent operation, to record and/or reproduce additional data to and/or from the nonvolatile memory, suspends processing the operation based on a normal request when the operation based on an urgent request is transmitted, and then processes the operation based on the urgent request. The device driver 200 will be described as an operation-processing-controlling device in the following drawings. The flash memory 240, e.g., a NAND flash memory, stores the data processed by the device driver 200. It is understood that the flash memory 240 is not limited to being a NAND flash memory, and may instead be various other types of nonvolatile memories known in the art, such as EEPROM, etc.

In the storage device 100 shown in FIG. 2, semaphores are used so that other operations based on other normal requests are not processed until an initial operation based on a normal request which is initially transmitted is completed. However, transmitting an urgent request enables the processing of read, write, or erase operations by suspending an operation based on a normal request even while the normal request is being processed. Accordingly, the storage device 100 is capable of quickly responding to an urgent request to process an urgent operation which should be processed quickly, such as, for example, processing a code necessary to use a real-time application.

An urgent-request-processing routine 210 suspends processing of an operation based on a normal request while a normal-request-processing routine 230 is operating. To suspend the processing of the operation based on a normal request, the normal-request-processing routine 230 checks whether an operation to process a normal request has been suspended for an operation to process an urgent request while the normal operation was being processed. Specifically, the normal-request-processing routine 230 checks a pre-empt flag 226 which indicates whether the operation based on the normal request was suspended.

For example, the normal-request-processing routine 230 sets the pre-empt flag as “0” before processing a normal request, and processes the operation based on the normal request. Furthermore, the urgent-request-processing routine 210 sets the pre-empt flag as “1” whenever processing an urgent request. Then, the normal-request-processing routine 230 determines whether to re-process the operation for a normal read, write, or erase request by checking the pre-empt flag 226. If the storage device 100 having a nonvolatile memory supports suspend or resume commands, the storage device 100 keeps processing reading, writing and/or erasing operations using the suspend and resume commands without having to re-perform writing or erasing.

When the storage device 100 having the nonvolatile memory is processing an operation based on a normal request, an urgent request may be processed after an operation for a normal request is suspended, or may be processed after the operation for a normal request is completed. During processing of an operation based on a normal request, the storage device 100 is ready to store data but the normal-request-processing routine 230 has not yet checked the status register value. If the urgent-request-processing routine 210 performs read, write, or erase operations, a result of processing the urgent request is reflected in the status register of the storage device 100. Therefore, there is a problem in that the normal-request-processing routine 230 cannot determine the result of operations based on normal requests that were performed. To solve this problem, the urgent-request-processing routine 210 stores the result of the operations that were processed in a backup status 224, and sets the status-backup flag 222 to “1” to indicate that an operation based on a normal request was performed. When the pre-empt flag is 226 set to “1” and the status-backup flag 222 is also set to “1,” the normal-request-processing routine 230 verifies the result of processing the operations that were performed by checking the stored backup status 224 in the flag unit 220.

Also, the urgent-request-processing routine 210 performs other operations according to the types of operations being processed. To perform these other operations, the urgent-request-processing routine 210 should determine the type of the operation processed based on a normal request. The flash memory 240 indicates a type of the operation being processed using the status register. However, in some cases a memory which is not supported as hardware is used. In this case, when the operations based on normal requests are performed, the corresponding operation type is set using an operation type flag to enable the urgent-request-processing routine 210 to determine processing information at a later time.

In some situations, the flash memory 240 may need to reset the storage device 100 in order to suspend the flash input/output (I/O) operations being performed and to perform a new flash I/O operation. In this case, when the flash memory 240 begins performing a new flash I/O operation after suspending the flash I/O operations being performed, the urgent-request-processing routine 210 sends a reset command to the storage device 100, and processes the operation based on the urgent request.

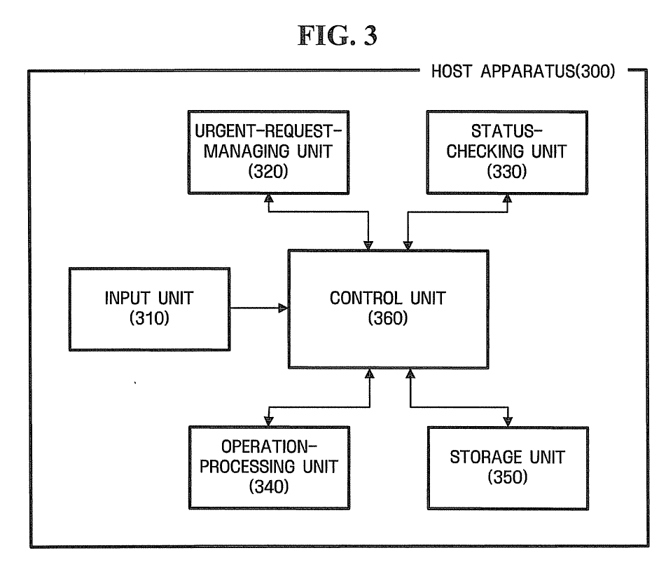

FIG. 3 is a block diagram showing a host apparatus 300 to control operations in a nonvolatile memory according to an example embodiment of the present invention. Such a host apparatus can be, for example, a mobile phone, a laptop computer, a PDA, and many other types of mobile devices. However, aspects of the present invention are not limited to being used in a mobile device, and may also be used in stationary devices, such as desktop computers. As shown in FIG. 3, a host apparatus 300 includes an input unit 310, an urgent-request-managing unit 320, a status-checking unit 330, an operation-processing unit 340, a storage unit 350, and a control unit 360.

The term “unit,” as used herein, refers to, but is not limited to referring to, a software or hardware component, such as a Field Programmable Gate Array (FPGA) or an Application Specific Integrated Circuit (ASIC), which performs certain tasks. A module may advantageously be configured to reside in the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

The input unit 310 receives a command to process operations based on normal requests and urgent requests transmitted from a user-input unit (not shown). The user input unit may be embodied in a variety of forms, such as, for example, a keyboard, buttons, a computer mouse, a touch screen, etc., and may be used with a host memory or an application.

The urgent request-managing unit 320 sets values of a pre-empt flag 226 and a status-backup flag 222. If an operation to process a normal request is suspended because an operation to process an urgent request is transmitted while the operation to process the normal request is being processed, the urgent-request-managing unit 320 sets the pre-empt flag 226 to “1.” Otherwise, when an operation to process a normal request is processed, the pre-empt flag 226 is initialized, or set, to “0.”

If a result of processing the operation based on the normal request is not verified because the operation based on the urgent request is transmitted after the operation based on the normal request is completed, the urgent-request-managing unit 320 instructs the control unit 360 to store the processing result of the operation based on the normal request in the storage unit 350. If the result of processing the operation based on the normal request is stored in the storage unit 350, the urgent request-managing unit 320 sets the status-backup flag 222 to “1” in order to indicate that the result of processing the operation based on the normal request is stored in the storage unit 350.

The status-checking unit 330, which checks a setting value of the pre-empt flag 226 and the status-backup flag 222 set by the urgent-request-managing unit 320, checks whether the operation based on the urgent request is performed using the pre-empt flag 226 and whether the operation based on the normal request is performed using the status-backup flag 222. If the operation-controlling apparatus 200 performs the operation based on the urgent request after the operation based on a normal request is completed, the result of the operation based on the normal request is stored in the storage unit 350, and the urgent request-managing unit 320 sets the status-backup flag 222 to “1.” Then, the status-checking unit 330 can determine whether the result of processing the operation based on the normal request is stored by checking the status-backup flag 222.

The operation-processing unit 340 processes operations based on normal and urgent requests. When an operation based on the urgent request is transmitted, the operation-processing unit 340 suspends processing of the operation based on the normal request, and preferentially performs the operation based on the urgent request. According to an aspect of the present invention, the operation-processing unit 340 has two different processing units to perform respective operations based on normal requests and urgent requests. When a user transmits the operation for the urgent request to the operation-processing unit 340, the operation-processing unit 340 automatically suspends processing the operation being processed based on the normal request, or switches into a standby mode and maintains the standby mode with respect to the operation based on the normal request until the operation being processed is completed. It is understood that the operation-processing unit 340 is not limited to having two different processing units to process the respective operations based on normal requests and urgent requests, and may instead have one processing unit to process both normal and urgent requests, or may have more than two processing units to separately process various types of normal and/or urgent requests separately, such as, for example, read, write, and erase operations.

The operation-processing unit 340 performs the operation based on the normal request according to a value of the pre-empt flag 226 which is checked by the status-checking unit 330, after the operation-processing unit 340 has completed the operation based on the urgent request. If the pre-empt flag 226 checked by the status-checking unit 330 is “1,” the operation-processing unit 340 determines that the operation to process the urgent request was processed while the operation to process the normal request was being processed, and re-performs the operation to process the normal request. It is understood that the pre-empt flag 226 is not limited to indicating “1” to indicate that the urgent request was processed, and may instead be set to any predetermined value to indicate that the urgent request was processed. Additionally, it is understood that the status-backup flag 222 is not limited to indicating “1” to indicate that the operation based on the normal request is stored, and may be set to any predetermined value.

If the pre-empt flag 226 checked by the status-checking unit 330 is “1” and the status-backup flag 222 checked by the status-checking unit 330 is also “1,” the operation-processing unit 340 determines that the operation based on the urgent request was processed after the operation to process the normal request was completed. Then, the operation-processing unit 340 checks the result of processing the operation based on the normal request which is stored in the storage unit 350.

The storage unit 350 stores data processed by the operation-processing unit 340 and the result of processing the operation based on the normal request that was suspended due to an urgent request being transmitted via the input unit 310. The storage unit 350 may be various types of memories, such as a NAND flash memory, a NOR flash memory, or other types memories.

The control unit 360 controls each of the functional components represented by blocks 310, 320, 330, 340, and 350 included in the host apparatus 300. The control unit 360 may be various types of control units known in the art, such as a Field Programmable Gate Array (FPGA), an Application Specific Integrated Circuit (ASIC), a microprocessor, etc.

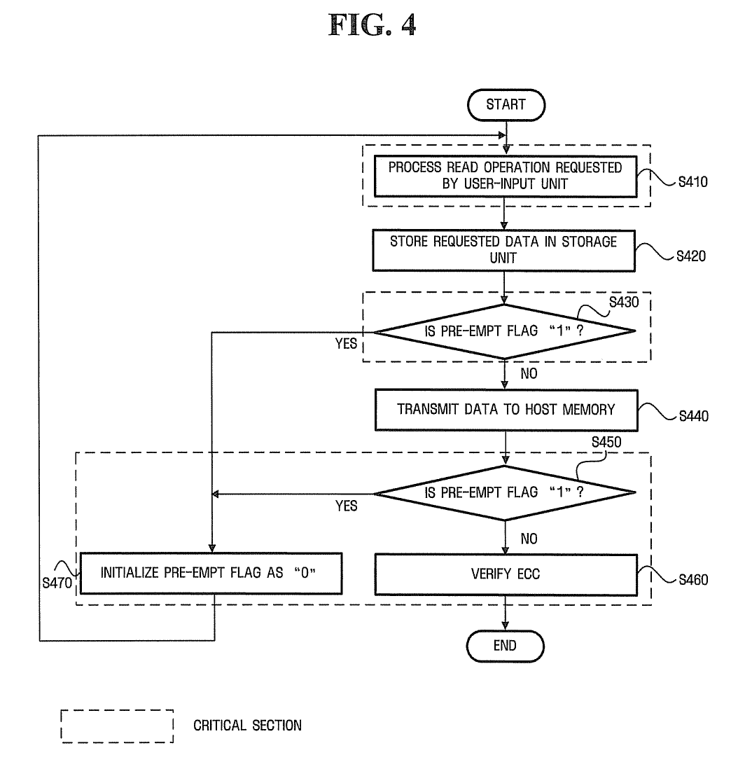

FIG. 4 is a flowchart of processing operations based on a normal read request transmitted to a nonvolatile memory, according to an example embodiment of the present invention. It is assumed that the nonvolatile memory indicates the type of an operation being performed.

At operation 410, the operation-processing unit 340 processes a read operation requested by the input unit 310. At this time, the pre-empt flag 226 has been set to “0.” Operations S410, S430, S450, S460, and S470 are referred to as “critical section areas,” as indicated by boxes with dotted line perimeters drawn around these operations. In a critical section area, no software context switching occurs. In other words, in a critical section area, there are no urgent requests because other operations are not processed in the critical section area.

At operation S420, the operation-processing unit 340 loads the requested data in the storage unit 350. At operation S430, the operation-processing unit 340 checks whether the pre-empt flag 226 checked by the status-checking unit 330 is “1.” Operation S430 is performed to check whether an operation to process an urgent request is being performed.

If the operation-processing unit 340 determines that the pre-empt flag 226 is not “1” at operation S430, the operation-processing unit 340 transmits the loaded data to the host memory at operation S440. After the loaded data has been transmitted from the operation-processing unit 340 to the host memory at operation S440, the operation-processing unit 340 checks whether the data transmission was suspended to process the operation based on the urgent request by re-checking the pre-empt flag 226 at operation S450.

If the operation-processing unit 340 determines that the pre-empt flag 226 is not “1” at operation S450, the operation-processing unit 340 verifies the error checking code (ECC) of the transmitted data at operation S460. It is understood that a wide variety of ECC may be used with the transmitted data, such as Hamming code, Reed-Solomon code, etc. It is further understood that ECC is not required to be used with the transmitted data.

If the operation-processing unit 340 determines that the pre-empt flag is “1” at operation S430, the operation-processing unit 340 determines that the operation to process the urgent request was processed. Then, at operation S470, the operation-processing unit 340 sets the pre-empt flag 226 as “0”, and then processes the read operation from the start at operation S410.

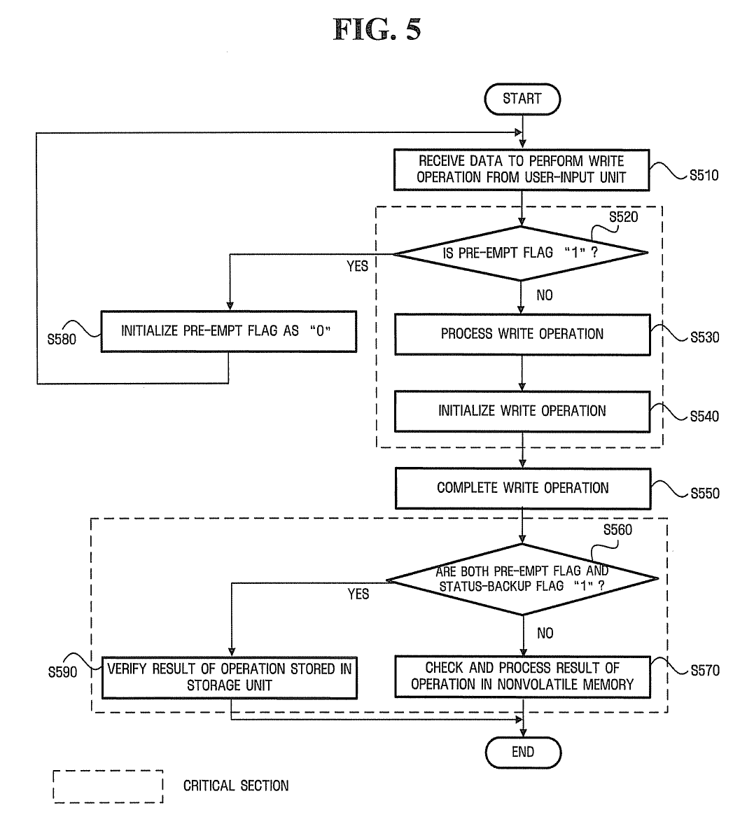

FIG. 5 is a flowchart of processing operations based on a normal write request transmitted to a nonvolatile memory, according to an example embodiment of the present invention. First, at operation S510, the user-input unit transmits data to the input unit 310 to be written to the flash memory 300. At this point, the pre-empt flag 226 has been initialized, or set, to “0.”

After the data has been transmitted to the input unit 310 at operation S510, the status-checking unit 330 checks the setting value of the pre-empt flag 226 in order to check whether an operation to process an urgent request is being performed at operation S520. Here, operations S520, S530, S540, S560, S570, and S590 are “critical section” areas, like the critical section areas described above with reference to FIG. 4. As described above, there is no software context switch in the critical section areas, in other words, no urgent requests are processed in the critical section areas because other operations are not processed in the critical section areas.

If the status-checking unit 330 determines that the pre-empt flag 226 is set to “1” at operation S520, the status-checking unit 330 determines that an urgent request to process an operation was processed while the write operation was being processed. Accordingly, at operation S580, the operation-processing unit 340 initializes, or sets, the pre-empt flag 226 as “0”, and then processes a write operation from the start at operation S510.

If the status-checking unit 330 determines that the pre-empt flag 226 is not “1” at operation S520, the operation-processing unit 340 processes the write operation for the loaded data at operation S530, and initializes the write operation, or in other words, sets the status-backup flag 222 as “0,” at operation S540. If the operation based on the urgent request was processed while the write operation was being processed at operation S530, the recently processed result of the write operation processed at operation S530 is lost. Therefore, operation S540 is performed to store the recently processed result of the write operation by initializing the status-backup flag 222 to “0” when the operation for the urgent request is performed.

After the operation-processing unit 340 completes processing the write operation at operation S550, the status-checking unit 330 checks the pre-empt flag 226 and the status-backup flag 222 in order to check whether the pre-empt flag 226 is “1” and the status-backup flag 222 is “1” at operation S560. If the status-checking unit 330 determines that both the pre-empt flag 226 and the status-backup flag 222 are “1” at operation S560, the status-checking unit 330 determines that an operation to process an urgent request was performed after the write operation was completed. Accordingly, the operation-processing unit 340 stores a result of the operation processed before the operation for the urgent request was processed in the storage unit 350. At operation S590, the operation-processing unit 340 verifies the result of the write operation stored in the storage unit 350.

If the status-checking unit 330 determines that neither the pre-empt flag 226 nor the status-backup flag 222 are “1” at operation S560, the status-checking unit 230 determines that no operation for the urgent request was processed while the write operation was processed. Accordingly, the operation-processing unit 340 stores the result of the write operation in a nonvolatile memory, such as the flash memory 240 (FIG. 2), and verifies the result of the write operation stored in the nonvolatile memory at operation S570.

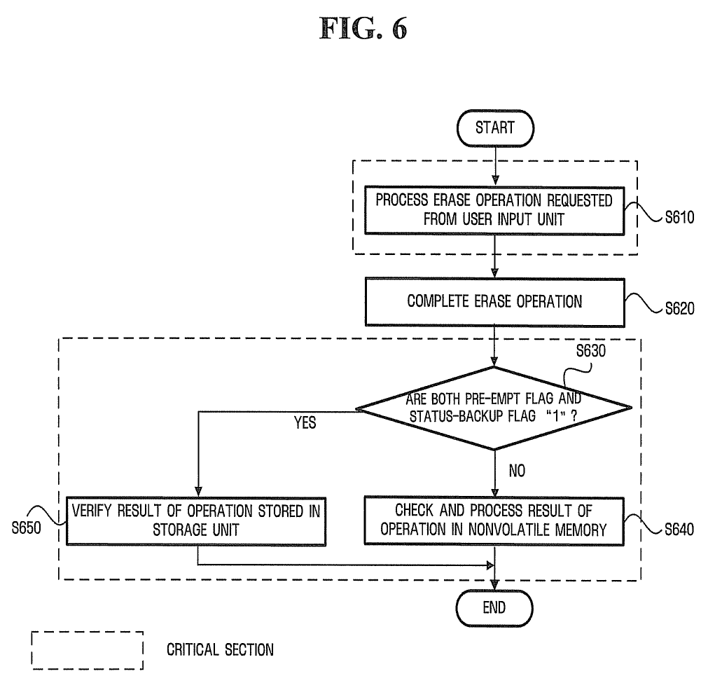

FIG. 6 is a flowchart of processing operations based on a normal erase request transmitted to a nonvolatile memory, according to an example embodiment of the present invention. At operation S610, the operation-processing unit 340 processes an erase operation requested by the user-input unit 310. At this point, the pre-empt flag 226 and the status-backup flag 222 have been initialized, or set, to “0”. Operations S610, S630, S640, and S650 are critical section areas like the critical section areas described above with reference to FIG. 4. As described above, there is no software context switch in the critical section areas, in other words, no urgent requests are processed in the critical section areas because other operations are not processed in the critical section areas.

The operation-processing unit 340 completes the erase operation at operation S620. The status-checking unit 330 checks whether both the pre-empt flag 226 and the status-backup flag 222 are “1” at operation S630.

If the status-checking unit 330 determines that both the pre-empt flag 226 and the status-backup flag 222 are “1” at operation S630, the status-checking unit 330 determines that an operation based on an urgent request was processed after the erase operation was completed at operation S620. Accordingly, the operation-processing unit 340 stores the result of the operation processed before the operation based on the urgent request is processed in the storage unit 350. At operation S650, the operation-processing unit 340 verifies the result of the erase operation stored in the storage unit 350.

If the status-checking unit 330 determines that neither the pre-empt flag 226 nor the status-backup flag 222 are “1” at operation S630, the status-checking unit 330 determines that the operation-processing unit 340 did not process any operations based urgent requests during the erase operation. At operation S640, the operation-processing unit 340 verifies the result of the erase operation in the nonvolatile memory.

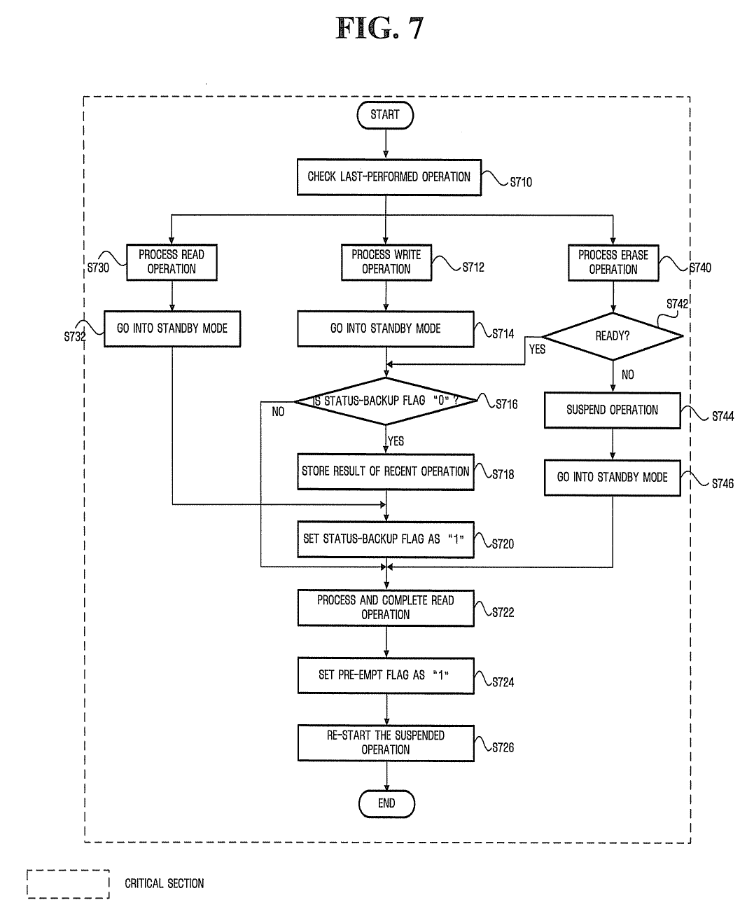

FIG. 7 is a flowchart of processing operations based on an urgent read request transmitted to a nonvolatile memory according to an example embodiment of the present invention. When the operation based on the urgent read request is transmitted, the operation performed most recently is checked by checking information on the performed operations at operation S710. Each of the operations performed in FIG. 7 are within a critical section area, as described above with reference to FIG. 4. As described above, in a critical section area, there is no software context switch, in other words, there is no processing of an urgent request because other operations are not processed in the critical section area.

After operation S710, if the operation-processing unit 340 performs an operation based on a normal write request at operation S712, the host apparatus 300 goes into standby mode until the status of the host apparatus 300 is “ready” at operation S714. When the status of the host apparatus 300 is “ready,” the status-checking unit 330 checks if the value of the status-backup flag 222 is “0” at operation S716.

If the status-checking unit 330 determines that the status-backup flag 222 is “0” at operation S716, the operation-processing unit 340 stores the result of the operation based on the normal write request at operation S718, before processing the operation based on the urgent read request. Then, at operation S720 the urgent-request-managing unit 320 sets the status-backup flag 222 as “1.” On the other hand, if the status-checking unit 330 determines that the status-backup flag 222 is not “0,” i.e., the status-backup flag 222 is “1,” at operation S716, the operation-processing unit 340 processes the operation based on the urgent read request without performing operations S718 and S720 because the result of the write operation was stored in the storage unit 350. When the operation-processing unit 340 completes the processing of the operation based on the urgent read request at operation S722, the urgent-request-managing unit 320 sets the pre-empt flag 226 to “1” at operation S724. Then, the operation-processing unit 340 re-starts the operation based on the normal write request at operation S726.

After operation S710, if the operation-processing unit 340 processes an operation based on a normal read request at operation S730, the operation-processing unit 340 moves into standby mode at operation S732 until the status of the host apparatus 300 changes to “ready.” When the status of the host apparatus 300 is “ready,” the urgent-request-managing unit 230 sets the setting value of the status-backup flag 222 as “1” at operation S720. Then, operations S720, S722, S724, and S726 are performed.

After operation S710, if the operation-processing unit 340 processes an operation based on a normal erase request at operation S740, it is checked whether the host apparatus 300 is in ready status or busy status at operation S742. If the host apparatus 300 is not in ready status i.e., if the host apparatus 300 is in busy status, the erase operation being processed is suspended at operation S744, and the operation-processing unit 340 is moved into standby mode at S746 until the host apparatus 300 changes to “ready” status. When the host apparatus 300 is in “ready” status, the operation-processing unit 340 processes the operation based on the urgent read request at operation S722. Then, operations S720, S722, S724 and S726 are performed.

As described above with reference to FIG. 7, the operation-processing unit 340 does not process the operation based on the urgent request until the host apparatus 300 is in “ready” status. However, aspects of the present invention are not limited to the operation-processing unit 340 waiting until the host apparatus 300 is in the “ready” status to process the operation based on the urgent request. For example, the operation-processing unit 340 may automatically process the operation based on the urgent request without waiting for the host apparatus 300 to change to “ready” status.

Aspects of the present invention are applicable to not only operations based on an urgent read request, but also operations based on urgent write and/or erase requests. Additionally, aspects of the present invention are not limited to performing a single read, write, or erase operation, but may also perform a combination of these operations or may perform other types of operations as well.

As described above, the apparatus and method to control operation processing in a nonvolatile memory according to aspects of the present invention produces one or more of the following effect. For a nonvolatile memory that does not support a hardware partition, the apparatus and method according to aspects of the present invention suspend the operation being processed in order to process an urgent read, write, or erase operation using software.

Various components of the host apparatus 300, as shown in FIG. 3, such as the urgent-request-managing unit 320, the status-checking unit 330, and the operation-processing unit 340, can be integrated into a single control unit, or alternatively, can be implemented in software or hardware, such as, for example, an application specific integrated circuit (ASIC). As such, it is intended that the processes described herein be broadly interpreted as being equivalently performed by software, hardware, or a combination thereof. As previously discussed, software modules can be written, via a variety of software languages, including C, C++, Java, Visual Basic, and many others. Instructions of the software routines or modules may also be loaded or transported into the wireless cards or any computing devices on the wireless network in one of many different ways. For example, code segments including instructions stored on floppy discs, CD or DVD media, a hard disk, or transported through a network interface card, modem, or other interface device may be loaded into the system and executed as corresponding software routines or modules. In the loading or transport process, data signals that are embodied as carrier waves (transmitted over telephone lines, network lines, wireless links, cables, and the like) may communicate the code segments, including instructions, to the network node or element. Such carrier waves may be in the form of electrical, optical, acoustical, electromagnetic, or other types of signals.

In addition, aspects of the present invention can also be embodied as computer readable codes on a computer readable recording medium. The computer readable recording medium is any data storage device that can store data which can be thereafter read by a computer system. Examples of the computer readable recording medium also include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing aspects of the present invention can be easily construed by programmers skilled in the art to which aspects of the present invention pertain.

While there have been illustrated and described what are considered to be example embodiments of the present invention, it will be understood by those skilled in the art and as technology develops that various changes and modifications may be made, and equivalents may be substituted for elements thereof without departing from the true scope of the present invention. Many modifications, permutations, additions and sub-combinations may be made to adapt the teachings of the present invention to a particular situation without departing from the scope thereof. Alternative embodiments of the invention can be implemented as a computer program product for use with a computer system. Such a computer program product can be, for example, a series of computer instructions stored on a tangible data recording medium, such as a diskette, CD-ROM, ROM, or fixed disk, or embodied in a computer data signal, the signal being transmitted over a tangible medium or a wireless medium, for example microwave or infrared. Accordingly, it is intended, therefore, that the present invention not be limited to the various example embodiments disclosed, but that the present invention includes all embodiments falling within the scope of the appended claims.

What is claimed is:

1. An apparatus to control operations of a nonvolatile memory, the apparatus comprising:
an urgent-request-managing unit to set a value of a pre-empt flag and a value of a status-backup flag when an operation based on an urgent request is transmitted;
a status-checking unit to check the set values of the pre-empt flag and the status-backup flag; and
an operation-processing unit to process the operation based on the urgent request and an operation based on a normal request according to the checked values.

2. The apparatus of claim 1, wherein the pre-empt flag is used to check whether the operation based on the urgent request was processed using the set value of the pre-empt flag, and the status-backup flag is used to check whether a result of the operation based on the normal request is stored using the set value of the status-backup flag.

3. The apparatus of claim 1, wherein when the operation based on the urgent request is transmitted, the operation-processing unit suspends the operation based on the normal request.

4. The apparatus of claim 1, further comprising:
a storage unit to store a result of the operation based on the normal request.

5. The apparatus of claim 1, further comprising an input unit to input the urgent request and the normal request.

6. The apparatus of claim 1, wherein the nonvolatile memory comprises a NAND flash memory.

7. The apparatus of claim 1, wherein the nonvolatile memory does not support a hardware partition.

8. The apparatus of claim 1, wherein the operation-processing unit comprises separate processors to respectively process the operation based on the urgent request and the operation based on the normal request.

9. A method of controlling operations of a nonvolatile memory, the method comprising:
maintaining a standby mode until an operation based on a normal request is completed, when an urgent request to process an operation is transmitted;
setting a value of a status-backup flag after the operation based on the normal request is completed;
processing the operation based on the urgent request; and
setting a value of a pre-empt flag when the operation based on the urgent request is completed.

10. The method of claim 9, further comprising:
processing the operation based on the normal request; and
storing a result of the processing of the operation based on the normal request after the operation based on the normal request is completed.

11. The method of claim 9, wherein the pre-empt flag is used to check whether the operation based on the urgent request was processed using the set value of the pre-empt flag and the status-backup flag is used to check whether a result of the operation based on the normal request is stored using the set value of the status-backup flag.

12. The method of claim 9, wherein, if both the value of the status-backup flag and the value of the pre-empt flag are set to a predetermined value, a result of processing the operation based on the normal request is checked.

13. The method of claim 9, further comprising:
checking the value of the pre-empt flag; checking; and
processing the operation based on the normal request.

14. The method of claim 9, further comprising:
suspending the operation based on the normal request for the operation based on the urgent request;
processing the operation based on the urgent request; and
setting the value of the pre-empt flag after the operation based on the urgent request is completed.

15. An apparatus to control operations of a nonvolatile memory, the apparatus comprising:
an input unit to input a request to perform a normal operation to record and/or reproduce data to and or from a nonvolatile memory and a request to perform an urgent operation having a higher priority than the normal operation to record and/or reproduce additional data to and/or from the nonvolatile memory; and
an operation-processing unit to process the normal operation and the urgent operation, wherein when the request to perform the urgent operation is input to the input unit, the operation-processing unit preferentially processes the urgent operation relative to the normal operation.

16. The apparatus of claim 15, further comprising:
an urgent-request-managing unit to set a value of a pre-empt flag and a value of a status-backup flag; and
a status-checking unit to check the set values of the pre-empt flag and the status-backup flag, wherein the operation-processing unit preferentially processes the urgent operation according to the checked values.

17. The apparatus of claim 16, wherein the urgent-request-managing unit sets the value of the pre-empt flag to a predetermined value to indicate that the request to process the urgent operation is transmitted, and sets the value of the status-backup flag to another predetermined value to indicate that the normal operation is stored.

18. The apparatus of claim 16, wherein if the status-checking unit determines that the set value of the pre-empt flag indicates that the request to process the urgent operation is transmitted, the operation-processing unit suspends the normal operation.

19. The apparatus of claim 17, wherein if the status-checking unit determines that the set value of the status-backup flag indicates that a result of the normal operation is stored, the operation-processing unit verifies the result of the stored normal operation.

20. The apparatus of claim 15, wherein the nonvolatile memory does not support a hardware partition.

21. A method of controlling operations of a nonvolatile memory, the method comprising:
inputting a request to perform a normal operation to record and/or reproduce data to and/or from a nonvolatile memory and a request to perform an urgent operation having a higher priority than the normal operation to record and/or reproduce additional data to and/or from the nonvolatile memory; and
preferentially performing the urgent operation relative to the normal operation when the request to perform the urgent operation is input.

22. The method of claim 21, wherein the preferentially performing the urgent operation comprises:
maintaining a standby mode with respect to the normal operation; and
performing the urgent operation during the maintaining of the standby mode.

23. The method of claim 21, wherein the preferentially performing the urgent operation comprises:
setting a value of a pre-empt flag according to whether the request to perform the urgent operation is input;
checking the set value of the pre-empt flag; and
performing the urgent operation according to a result of the checking.
